(19) United States
(12) Patent Application Publication
(10) Pub. No.: US 2023/0169662 A1
(43) Pub. Date: Jun. 1, 2023

(54) SYSTEM AND METHOD FOR GENERATING A MORPHOLOGICAL ATLAS OF AN EMBRYO

(71) Applicant: Centre for Intelligent Multidimensional Data Analysis Limited, Hong Kong (CN)

(72) Inventors: Jianfeng CAO, Hong Kong (CN); Hong YAN, Hong Kong (CN)

(21) Appl. No.: 17/536,377

(22) Filed: Nov. 29, 2021

(51) Int. Cl. G06T 7/155; G06T 7/11; G06T 7/70

(52) U.S. Cl. CPC G06T 7/155; G06T 7/11; G06T 7/70; G06T 2207/30044; G06T 2207/20036; G06T 2200/04; G06T 2207/20128; G06T 2207/20081; G06T 2207/20084; G06T 2207/20156; G06T 2207/20152

(57) ABSTRACT

A method for generating a morphological atlas of an embryo including the steps of receiving a plurality of 3D images of the embryo representative of the morphological process of embryonic cells from a first predetermined cell population to a second predetermined cell population; processing the plurality of 3D images to derive nucleus lineage information associated with each nucleus of the embryonic cells during the morphological process; performing a membrane segmentation procedure to segment the 3D images into membrane segments; and combining the nucleus lineage information and the membrane segments to generate the morphological atlas of the embryo.

### TECHNICAL FIELD

This invention relates to a method and system for generating a morphological atlas of an embryo.

### BACKGROUND

Embryogenesis in metazoans involves multidimensional spatiotemporal cellular changes, including cell proliferation, differentiation, and morphogenesis. During metazoan embryogenesis, cell morphology is tightly associated with several biological processes, including cell-cycle control, spindle formation, cell-fate asymmetry and differentiation, intercellular signalling, cytomechanics, morphogenesis, and organogenesis. However, a deeper understanding of changes in cell morphology during development (i.e. cell shape, cell size, and cell neighbourhood) is desired.

Although recent advances in confocal microscopy have promoted in vivo 4D imaging of an embryo throughout embryogenesis, this typically involves large quantities of volumetric imaging data which makes visual identification tedious. Deep-learning-based methods are promising tools for recognition tasks, such as denoising and image synthesis. A system and method for efficient analysis of image data is desired.

### SUMMARY OF THE INVENTION

According to a first aspect of the invention, there is provided a method for generating a morphological atlas of an embryo including the steps of: receiving a plurality of 3D images of the embryo representative of the morphological process of embryonic cells from a first predetermined cell population to a second predetermined cell population, processing the plurality of 3D images to derive nucleus lineage information associated with each nucleus of the embryonic cells during the morphological process, performing a membrane segmentation procedure to segment the 3D images into membrane segments, and combining the nucleus lineage information and the membrane segments to generate the morphological atlas of the embryo.

According to a second aspect of the invention, there is provided a system for generating a morphological atlas of an embryo including a cell imaging unit arranged to receive a plurality of 3D images of the embryo representative of the morphological process of embryonic cells from a first predetermined cell population to a second predetermined cell population, a nucleus tracing processor arranged to process the plurality of 3D images to derive nucleus lineage information associated with each nucleus of the embryonic cells during the morphological process, a membrane segmentation processor arranged to perform a membrane segmentation procedure to segment the 3D images into membrane segments; and a cell identification processor arranged to combine the nucleus lineage information and the membrane segments to generate the morphological atlas of the embryo.

In an embodiment of the first aspect, the membrane segmentation procedure includes a machine learning processor arranged to process the 3D images of the embryo to create a discrete distance map representative of the positions of membranes within the 3D images.

In an embodiment of the first aspect, the machine learning processor uses a distance aware neural network trained to determine the positions of the membranes within the 3D images with the pixel location of the membranes.

In an embodiment of the first aspect, the membrane segmentation procedure further includes the steps of a seeding procedure and a watershed segmentation procedure to perform the membrane segmentation.

In an embodiment of the first aspect, the step of combining the nucleus lineage information and the membrane segments identifies the embryonic cells and cavity within the 3D image.

In an embodiment of the first aspect, the combination of the nucleus lineage information and the membrane segments is arranged to devise cell shape, cell size, cell-cell contact, or any combination thereof.

In an embodiment of the first aspect, the nucleus lineage information, the membrane segments, cell shape, cell size, cell-cell contact, or any combination thereof, is presented as the morphological atlas of the embryo undergoing the morphological process from the first predetermined cell population to the second predetermined cell population.

the first predetermined cell population is 4, and the second predetermined cell population is 350.

In an embodiment of the first aspect, the embryo is a Caenorhabditis elegans embryo.

In an embodiment of the first aspect, the embryo is a Caenorhabditis elegans transgenic strain that expresses a GFP fluorescence marker and/or an mCherry fluorescence marker in the nuclei and/or membranes of the embryonic cells.

In an embodiment of the second aspect, the membrane segmentation processor includes a machine learning processor arranged to process the 3D images of the embryo to create a discrete distance map representative of the positions of the membranes within the 3D images.

In an embodiment of the second aspect, the machine learning processor uses a distance aware neural network trained to determine the positions of the membranes within the 3D images with the pixel location of the membranes.

In an embodiment of the second aspect, the membrane segmentation procedure further includes the steps of a seeding procedure and a watershed segmentation procedure to segment the 3D images into the membrane segments.

In an embodiment of the second aspect, the cell identification processor is arranged to combine the nucleus lineage information and the membrane segments to identify the embryonic cells and cavity within the 3D image.

In an embodiment of the second aspect, the cell identification processor is arranged to combine the nucleus lineage information and the membrane segments to devise cell shape, cell size, cell-cell contact, or any combination thereof.

In an embodiment of the second aspect, the nucleus lineage information, the membrane segments, cell shape, cell size, cell-cell contact, or any combination thereof, is presented as the morphological atlas of the embryo undergoing the morphological process from the first predetermined cell population to the second predetermined cell population.

In an embodiment of the second aspect, the first predetermined cell population is 4, and the second predetermined cell population is 350.

In an embodiment of the second aspect, the embryo is a Caenorhabditis elegans embryo.

In an embodiment of the second aspect, the embryo is a Caenorhabditis elegans transgenic strain that expresses a GFP fluorescence marker and/or an mCherry fluorescence marker in the nuclei and/or membranes of the embryonic cells.

The present invention advantageously provides a method and system that combines automated segmentation of membranes with automated cell lineage tracing to quantify morphological parameters of embryonic cells in developing embryos. A 3D atlas of cell morphology for an embryo is generated, including cell shape, volume, surface area, migration, nucleus position and cell-cell contact.

In one embodiment, the membrane segmentation procedure includes a machine learning processor arranged to process the 3D images of the embryo to create a discrete distance map representative of the positions of membranes within the 3D images. Preferably, the machine learning processor uses a distance aware neural network trained to determine the positions of the membranes within the 3D images with the pixel location of the membranes.

The discrete distance map provides a prediction probability distribution of the membranes thereby allowing for effective membrane segmentation, including membranes with weak signal.

In another embodiment, the membrane segmentation procedure further includes the steps of a seeding procedure and a watershed segmentation procedure to perform the membrane segmentation. The seeding strategy beneficially reduces over-segmentation errors.

Advantageously, the step of combining the nucleus lineage information and the membrane segments identifies the embryonic cells and cavity within the 3D image, and the combination of the nucleus lineage information and the membrane segments is arranged to devise cell shape, cell size, cell-cell contact, or any combination thereof. Systematic quantification of these factors aid in the predication of essential regulatory activities that manifest as stereotyped morphological dynamics during embryonic development.

In a preferred embodiment, the embryo is a Caenorhabditis elegans transgenic strain that expresses a GFP fluorescence marker and/or an mCherry fluorescence marker in the nuclei and/or membranes of the embryonic cells. In an example, the first predetermined cell population is 4, and the second predetermined cell population is 350.

In a most preferred embodiment, the nucleus lineage information, the membrane segments, cell shape, cell size, cell-cell contact, or any combination thereof, is presented as the morphological atlas of the embryo undergoing the morphological process from the first predetermined cell population to the second predetermined cell population. The invention thus provides an efficient and accurate system and method for the reconstruction and visualisation of 3D shapes and temporal changes of embryonic cells during development.

### BRIEF DESCRIPTION OF THE DRAWINGS

Embodiments of the present invention will now be described, by way of example, with reference to the accompanying drawings in which:

FIG. 1 is a block diagram of a computer system arranged to be implemented to operate as a system for generating a morphological atlas of an embryo in accordance with an example embodiment.

FIG. 2 is a block diagram of a system for generating a morphological atlas of an embryo in accordance with an example embodiment.

FIG. 3 is a flowchart of a method for generating a morphological atlas of an embryo in accordance with an example embodiment.

FIG. 4A shows 3D images of GFP-labeled nuclei (green) and mCherry-labeled membranes (red) of embryonic cells at the 2-4 cell stages in accordance with an example embodiment.

FIG. 4B shows 3D images of GFP-labelled nuclei (green) and mCherry-labelled membranes (red) of embryonic cells at the 4-350 cell stages in accordance with an example embodiment.

FIG. 4C shows images of nuclei positions of the embryonic cells from the 4-350 cell stages as determined by a nucleus tracing processor in accordance with an example embodiment.

FIG. 5A is a bar chart showing the dice ratio generated during the membrane segmentation procedure in accordance with an example embodiment.

FIG. 5B is a graph showing the results of the membrane segmentation procedure in accordance with an example embodiment.

FIG. 5C is a graph illustrating the benchmarking of the membrane segmentation procedure in accordance with an example embodiment.

### DETAILED DESCRIPTION OF THE PREFERRED EMBODIMENT

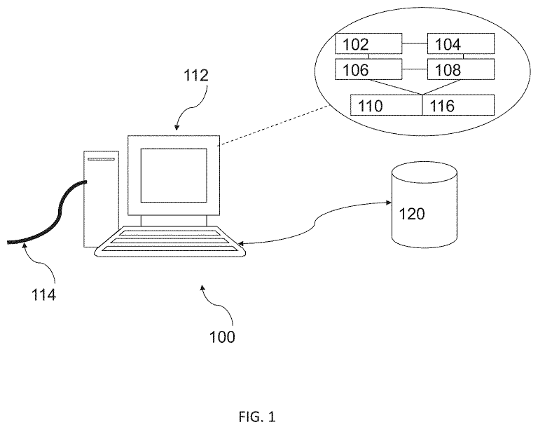

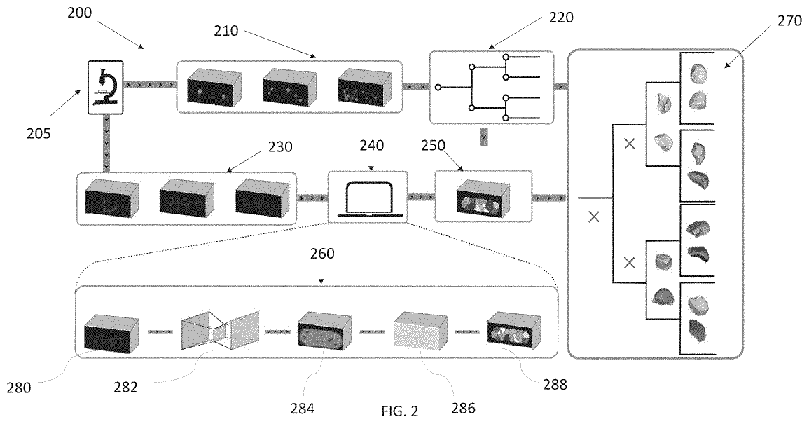

With reference to FIGS. 1 and 2, an embodiment of the present invention is illustrated. This embodiment is arranged to provide a system and method for generating a morphological atlas of an embryo, comprising: receiving a plurality of 3D images of the embryo representative of the morphological process of embryonic cells from a first predetermined cell population to a second predetermined cell population, processing the plurality of 3D images to derive nucleus lineage information associated with each nucleus of the embryonic cells during the morphological process, performing a membrane segmentation procedure to segment the 3D images into membrane segments, and combining the nucleus lineage information and the membrane segments to generate the morphological atlas of the embryo.

In this example embodiment, the interface and processor are implemented by a computer having an appropriate user interface. The computer may be implemented by any computing architecture, including portable computers, tablet computers, stand-alone Personal Computers (PCs), smart devices, Internet of Things (IOT) devices, edge computing devices, client/server architecture, “dumb” terminal/mainframe architecture, cloud-computing based architecture, or any other appropriate architecture. The computing device may be appropriately programmed to implement the invention.

The system and method of the invention is arranged to generate a morphological atlas of an embryo by detecting cell membranes and building up cell shapes of embryonic cells in 3D and automatically segmenting the cell images at a cellular level such that scientists are able to decipher the contents of these images quickly and with minimal input. The system and method of the invention thus can characterise cell shapes and surface structures, and advantageously provide 3D views of cells at different time points.

Turning first to FIG. 1, there is a shown a schematic diagram of a computer system or computer server 100 which is arranged to be implemented as an example embodiment of a system for generating a morphological atlas of an embryo. This embodiment comprises a server 100 which includes suitable components necessary to receive, store and execute appropriate computer instructions. The components may include a processing unit 102, including Central Processing United (CPUs), Math Co-Processing Unit (Math Processor), Graphic Processing United (GPUs) or Tensor processing united (TPUs) for tensor or multidimensional array calculations or manipulation operations, read-only memory (ROM) 104, random access memory (RAM) 106, and input/output devices such as disk drives 108, input devices 110 such as an Ethernet port, a USB port, etc. Display 112 such as a liquid crystal display, a light emitting display or any other suitable display and communications links 114 may also be present. The server 100 may include instructions that may be included in ROM 104, RAM 106 or disk drives 108 and may be executed by the processing unit 102. There may be provided a plurality of communication links 114 which may variously connect to one or more computing devices such as a server, personal computers, terminals, wireless or handheld computing devices, Internet of Things (IoT) devices, smart devices, edge computing devices. At least one of a plurality of communications link may be connected to an external computing network through a telephone line or other type of communications link.

The server 100 may also include storage devices such as a disk drive 108 which may encompass solid state drives, hard disk drives, optical drives, magnetic tape drives or remote or cloud-based storage devices. The server 100 may use a single disk drive or multiple disk drives, or a remote storage service. The server 100 may also have a suitable operating system 116 which resides on the disk drive or in the ROM of the server 100.

The computer or computing apparatus may also provide the necessary computational capabilities to operate or to interface with a machine learning network, such as a neural network, to provide various functions and outputs. The neural network may be implemented locally, or it may also be accessible or partially accessible via a server or cloud-based service. The machine learning network may also be untrained, partially trained or fully trained, and/or may also be retrained, adapted or updated over time.

FIG. 2 is a block diagram of a system 200 for constructing a 4D morphological atlas of an embryo during embryogenesis. A cell imaging unit 205 is arranged to receive a plurality of 3D images of the embryo representative of the morphological process of the embryonic cells from a first predetermined cell population to a second predetermined cell population. Preferably, the embryos are from a Caenorhabditis elegans transgenic strain that ubiquitously expresses both a green fluorescent protein (GFP) and a red mCherry fluorescence marker in the embryonic cell nuclei and membranes, respectively, throughout embryonic development.

A nucleus tracing processor 210 is arranged to process the plurality of 3D images to derive nucleus lineage information 230 associated with each nucleus of the embryonic cells during the morphological process, for example as a cell lineage tree as shown in FIG. 2.

A membrane segmentation processor 282 performs an automatic segmentation 240 in which a membrane segmentation procedure 260 segments the 3D membrane images 230 into distinct membrane segments. The membrane segmentation processor 282 is a trained distance-aware neural network module that is able to produce a discrete distance map 284 from the raw image 280 of the membranes.

The membrane segmentation processor 282 is trained to determine the positions of the membranes within the 3D images with the pixel location of the membranes. The membrane segmentation procedure 260 further includes the steps of minima clustering which serves as a seeding procedure 286, and a watershed segmentation procedure 288 to segment the 3D images 230 into the membrane segments.

The segmentation of cell membranes, unlike cell nuclei that are localised and well-separated ellipsoid components, is well known to be a difficult task due to the thin planar structure of membranes that form complicated networks. Accordingly, it may be difficult to obtain a strong signal of the membranes and laser attenuation makes segmentation of membranes more challenging, problems that are exacerbated when the membrane is parallel to the focal plane—affecting the overall quality of the membrane image. The generation of a discrete distance map, instead of segmenting cells as a binary classification task directly, allows for accurate and reliable segmentation of the cell membranes. Further, by learning to capture multiple discrete distances between image pixels, the membrane segmentation processor 230 extracts the membrane contour while considering shape information, rather than just intensity features thereby allowing for effective segmentation of membranes with weak or weaker signal.

The cell identification processor 250 then combines the nucleus lineage information 220 derived from the nucleus tracing processor 210 with the membrane segments to identify the embryonic cells and cavity within the 3D image. The membrane-wrapped compartments in the segmentations with a nucleus are denoted as cells and the membrane-wrapped compartments without a nucleus are denoted as a cavity. The cell identification processor 250 uses this information to devise morphological parameters such as cell shape, cell size, cell-cell contact, or any combination of these parameters. Time-lapse 3D cell shapes, or any other morphological parameters or combinations thereof, across development with defined cell identity are generated as a cell shape lineage 270.

The nucleus lineage information 220, the membrane segments, cell shape, cell size, cell-cell contact, or any combination thereof, is presented as a morphological atlas of the embryo undergoing the morphological process from a first predetermined cell population, for example 4 cells, to a second predetermined cell population, for example 350 cells.

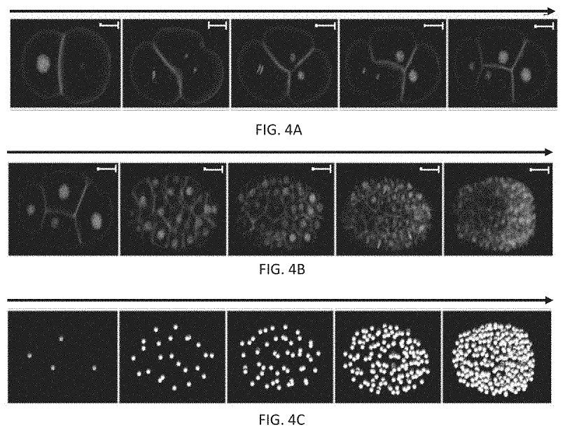

FIG. 4A shows 3D images of GFP-labelled nuclei (green) and mCherry-labelled membranes (red) of embryonic cells at the 2-4 cell stages and FIG. 4B shows 3D images of embryonic cells at the 4-350 cell stages. FIG. 4C shows images of nuclei positions of the embryonic cells from the 4-350 cell stages determined by the nucleus tracing processor 210.

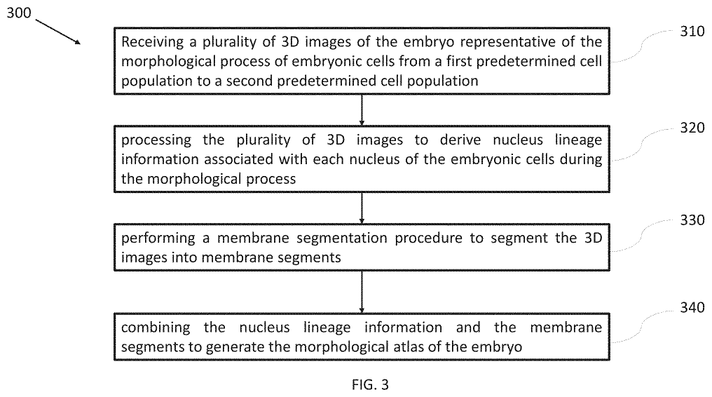

With reference to FIG. 3, the present invention is also directed to a method for generating a morphological atlas of an embryo as illustrated in the flowchart 300.

The first step 310 involves receiving a plurality of 3D images of the embryo representative of the morphological process of embryonic cells from a first predetermined cell population, for example 4 cells, to a second predetermined cell population, for example 350 cells. In a most preferred embodiment, the embryo is a Caenorhabditis elegans transgenic strain that expresses a GFP fluorescence marker and/or an mCherry fluorescence marker in the nuclei and/or membranes of the embryonic cells.

The second step 320 involves processing the plurality of 3D images to derive nucleus lineage information 220 associated with each nucleus of the embryonic cells during the morphological process.

A membrane segmentation procedure 260 is performed in step 330 to segment the 3D images into membrane segments. The membrane segmentation procedure 260 includes a machine learning processor 282 arranged to process the 3D images of the embryo to create a discrete distance map 284 representative of the positions of membranes within the 3D images. The machine learning processor uses a distance-aware neural network to determine the positions of the membranes within the 3D images with the pixel locations of the membranes.

In a preferred embodiment, the membrane segmentation procedure 260 includes the steps of a seeding procedure 286 and a watershed segmentation procedure 288 to perform the membrane segmentation.

Step 340 involves combining the nucleus lineage information 220 and the membrane segments to generate a morphological atlas of the embryo. This step identifies the embryonic cells and cavity within the 3D image and the combination of the nucleus lineage information and the membrane segments is used to devise cell shape, cell size, cell-cell contact, or any combination thereof. The nucleus lineage information, the membrane segments, cell shape, cell size, cell-cell contact, or any combination thereof, is presented as the morphological atlas of the embryo undergoing the morphological process from the first predetermined cell population to the second predetermined cell population.

Existing image analysis systems are directed at detecting cell nuclei with a poor cell membrane image quality, thus hampering reconstruction of cell shapes. Image segmentation is a critical process in developmental and cell biology and traditionally involves meticulous and time-consuming manual labelling of cell images. The segmentation of time-lapsed 3D images of cell division is currently lacking a reliable algorithm.

The system and method for generating a morphological atlas of the present invention advantageously provides a research tool that can reconstruct and visualise 3D shapes and temporal changes of cells, automating, simplifying and substantially speeding up the analysis process. The system of the present invention can detect cell membranes, build up cell shapes in 3D, and automatically segment the cell images at the cell level thus characterising cell shapes and surface structures, providing 3D views of cells at different time points. Utilising a distance aware neural network that captures multiple discrete distances between image pixels, membrane contour and shape information is captured thus achieving a high accuracy of identifying cells.

Although not required, the embodiments described with reference to the Figures can be implemented as an application programming interface (API) or as a series of libraries for use by a developer or can be included within another software application, such as a terminal or personal computer operating system or a portable computing device operating system. Generally, as program modules include routines, programs, objects, components and data files assisting in the performance of particular functions, the skilled person will understand that the functionality of the software application may be distributed across a number of routines, objects or components to achieve the same functionality desired herein.

It will also be appreciated that where the methods and systems of the present invention are either wholly implemented by computing system or partly implemented by computing systems then any appropriate computing system architecture may be utilised. This will include stand alone computers, network computers and dedicated hardware devices. Where the terms “computing system” and “computing device” are used, these terms are intended to cover any appropriate arrangement of computer hardware capable of implementing the function described.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

Any reference to prior art contained herein is not to be taken as an admission that the information is common general knowledge, unless otherwise indicated.

### EXAMPLES

### Example 1

### Methods

Preparation of C. elegans Strain

All animals were maintained on NGM plates seeded with OP50 at room temperature. Using Gibson Assembly, the construct Phis-72::PH(PLC1delta1)::mCherry::pie-1-3′UTR was made and cloned into a miniMos vector for transgenesis. The His-72 promoter and pie-1 UTR were used to achieve broad expression in both the soma and germline. A membrane labeling strain ZZY0637, carrying a single copy of this transgene, was generated using the mini-Mos technique. It was crossed with the nucleus labeling strain, RW10029, which ubiquitously expresses a fusion between histone (HIS-72) and GFP, enabling automated tracing and identification of nuclei. Both the nucleus and membrane markers were rendered homozygous in the resulting strain, ZZY0655, before automated lineaging and membrane segmentation.

### Image Acquisition

One- to four-celled embryos were dissected from the adult worms. They were mounted for imaging using 1% methylcellulose in Boyd's buffer with 20 μm Polybead® microspheres (Polysciences, Inc.) Imaging was performed with an inverted Leica SP5 and SP8 confocal microscope equipped with two hybrid detectors at a constant ambient temperature of 21° C. Images were consecutively collected for both GFP and mCherry channels using a water immersion objective. By using a resonance scanner, both channels were imaged with scanning speed of 8000 Hz with a frame size of 712×512 pixels per channel. The excitation laser beams used for GFP and mCherry are 488 nm (SP5 and SP8) and 594 nm (SP5) or 552 nm (SP8), respectively. Histone::GFP was used as a lineaging marker for cell tracing later, whereas PH2::mCherry was used as a membrane marker. Fluorescence images from 68 (SP5) or 70 (SP8) Z-steps were collected consecutively for three embryos per imaging session with a Z-resolution of 0.42 μm (SP5) or 0.43 μm (SP8) from top to bottom of the embryo for every timepoint, which was at ˜1.5-min interval. Images were continuously collected for at least 130 time points during which the cell count would reach over 350 in a wild-type embryo. The entire imaging duration was divided into four time blocks by time point that is 1-60-61-130-131-200 and 201-240. Z axis compensation was 0.4-4% for the 488 nm laser and 19-95% for the 594 nm laser in SP5, whereas 0.1-0.3% for the 488 nm laser (SP8) and 2-10% for the 552 nm laser (SP8). The pinhole sizes for the four blocks were 2.3,2,1.6, and 1.3 AU, respectively. Prior to image analysis, all images were subjected to deconvolution followed by resizing into isotonic volume images with a resolution of either 0.22 um (for training or evaluation) or 0.25 μm (for morphological atlas generation).

### Nucleus Tracing and Lineaging

The nuclei images were segmented and identified using StarryNite and visualized using AceTree21. The lineaging errors were manually corrected up to the 350-cell stage. The data quality was confirmed using quality-control standards. First, all the embryos must start to be imaged before AB2 divisions so that information of the four-cell stage can be obtained (i.e., ABa, ABp, EMS, and P2), which is essential for spatial normalization of different embryos. Second, the full lifespans of AB4-AB128, MS1-MS16, E1-E8, C1-C8, D1-D4, P3, and P4 cells have to be recorded. Third, their descendants, namely AB256,MS32,E16,C16,D8,Z2, and Z3 cells, have to be present for at least one time point Finally, the nucleus information, including position and name, was output in a separate file to be used for cell-membrane segmentation.

### Manual Annotation of Cell

A new data set was annotated and used to train the DMapNet and benchmark CShaper against existing methods. A gold standard data set was generated in a semiautomatic manner, in which segmentation errors from software were manually corrected by experts. The membrane stack was first pre-segmented by a traditional method for 3D membrane morphological segmentation (3DMMS), and then the output was checked by two experts with an interactive tool for semiautomatic segmentation of multi-modality biomedical images (ITK-SNAP) slice-by-slice. To aid manual examination of cavities formed among the neighbouring cells, nuclei images were incorporated alongside the membrane-based images. Most annotated embryos had fewer than 100 cells to prevent the deterioration of annotation accuracy with image quality and subsequent segmentation errors introduced by 3DMMS. The annotations are composed of cell-wise regions, which can be easily transformed into membrane masks through morphological operations. For training, 54 volumetric stacks with an average of 65 cells in each were annotated. Another 21 stacks with an average of 52 cells in each were also annotated in parallel for independent evaluation.

### Distance-Constrained Learning

During long-duration time-lapse imaging, it is desirable to collect each pixel with a sufficient number of photons, but the imaging frequency has to be limited to keep the embryo alive. Segmenting the embryo with low image quality is a challenging task. To solve this problem, a distance-aware network, DMapNet, is proposed to learn the cell shapes implicitly. DMapNet is able to discriminate weak membranes, especially in the periphery where only a single layer of membrane exists.

Given the input image I, we define Φ_i (I) as the corresponding ground truth of the binary membrane at pixel i, where foreground membrane and background pixels have values 1 and 0, respectively. With the membrane mask forming a single-pixel surface, the distance map M is formulated as:

$${i}_{} = \{ \begin{matrix}{min}_{{Φ}_{j} = 1} \{ {( x - {x}_{0} )}^{2} + {( y - {y}_{0} )}^{2} + {( z - {z}_{0} )}^{2} \} , & {Φ}_{i} = 0 \\ 0 , & {Φ}_{i} = 1\end{matrix} \qquad ( 3 )$$

$$= τ ( max \{ \} - , d ) \qquad ( 4 )$$

where x,y,z and x_0,y_0,z_0 represent the coordinates of pixels i and j, respectively. In Eq. (4), we reverse the distance map to keep it monotonically decreasing from the membrane to the background. The background here includes both cell interiors and external embryo background. Subsequently, a truncation function τ(\hat{ }*,d) sets values above d to d or otherwise retains the value. Due to the lack of distinctive features among far-away voxels. d is chosen such that it constitutes a smooth transformation from the foreground membrane to the background. By predicting M, DMapNet outputs the unnormalized probability of the voxel being the membrane. \hat{ }68,M is further nonlinearly discretized into M\hat{ }dξ{0, 1, . . . , K}3, the learning target, with smaller intervals around the membrane mask. The cross-entropy loss used to evaluate the learning progress is defined as:

$$l = {\sum }_{i = 1}^{N} {\sum }_{k = 1}^{K} {ξ}_{k} {ω}_{i , k} ( {i , l}_{d}^{} log {P}_{i , k} + ( 1 - {i , k}_{d}^{} ) log ( 1 - {P}_{i , k} ) )$$

_ik\hat{ }d is the kth element of the one-hot target vector at pixel i, and P_(i,k) is the counterpart in the output of DMapNet. N and K are the numbers of pixels and distance intervals, respectively. The importance of different classes is adjusted by the fixed weighting term ξ_k, which inclines to classes near the membrane. We also incorporate interclass relationships into the loss through an interclass weighting term, ω_ik. Compared with ξ_k,ω_ik dynamically changes depending on different predicted classes. This strategy is derived from the assumption that in ordered class prediction, one class closer to the ground truth is supposed to have a larger predicted probability. For example, for class k=1, a higher penalty should be imposed to a predicted class k\hat{ }′=15 than that of k\hat{ }′=2. Therefore, if the Kth interval denotes the center mask of the membrane, interclass weight ω_ik is calculated with:

$${ω}_{i , k} = exp ( \frac{\vert k - {i}_{d}^{} \vert}{K} ) \qquad ( 6 )$$

where M_i\hat{ }d is the ground truth class at pixel i.

### Network Structure

A pseudo-3D data flow is utilized throughout the network of DMapNet. In confocal imaging, a 3D stack is acquired by optical sectioning of embryos in the depth direction. Considering the thickness of the membrane, as well as the elongated light volume emitted by a single fluorescent molecule, only 24 consecutive slices are cropped as the input to DMapNet. It follows the structure of the U-Net with high-level abstraction information extracted by a down-sampling path and low-level features assembled by an up-sampling path. To ensure efficient gradient propagation. multiple residua blocks are leveraged at different down-sampling levels. While a 3×3×3 kernel car be decomposed into 3×3×1 and 1×1×3 kernels, the residual block only includes the 3×3×1 kernel in addition to the group normalization and Parametric Rectified Linear Unit layers. Before the max pooling, the 1×1×3 kernel is used to fuse the features of multiple channels. Dilation convolution is added to enlarge the receptive field. To aid the higher layers retain the raw image information, the input is scaled down and concatenated with corresponding high-level feature maps, which also boosts the performance in segmenting cells of different sizes \hat{ }40. In the up-sampling stage, all linearly up-sampled features are convoluted with the 3×3×1 kernel before being concatenated together. The class-wise probability: D×W×H×K⊂[0, 1K] is obtained by another convolution of the assembled features. Thereby, the distance map ψW:D×W×H⊂{0, 1, . . . , K} can be easily derived from ψ_i=arg max_kP_ik

DMapNet was implemented with TensorFlow and Python. Inputs were randomly cropped from 54 volumetric stacks of the size of 134×205×285. Adam optimization with an initial learning rate of 5×10\hat{ }(−4) was used to update parameters. By setting the batch size to 2, we trained the model for 5000 epochs on one NVIDIA 2080Ti GPU.

Watershed Segmentation with Automatic Seeding

Watershed segmentation is well suited for separating individual cells based on the distance map ψ. Here, we propose an automatic seeding procedure to facilitate the cellular segmentation by detecting appropriate seeds from the membrane mask.

The Kth class in ψ is regarded as the membrane mask ΦP. By selecting the background as the target voxel, Euclidean distance transformation is applied to ΦP, yielding M\hat{ }p. All local H-minima in M\hat{ }P are denoted as S={s_i}_(i=1, . . . , L) where L is the number of local minima. A weighted graph G is constructed to cluster s_i's that belong to one cell or background. Edges E={E_1,E_2} in G come from two sources: one is the Delaunay triangulation on S, noted as E_1, and the other is the edges, E_2 among all local minima locate on the boundary of the volume. The weight of edge e_ij is defined as:

$$W ( {e}_{ij} ) = \{ \begin{matrix}{\sum }_{( x , y , z ) ∈ {e}_{ij}} {P}^{} ( x , y , z ) , & {e}_{ij} ∈ {E}_{1} \\ 0 , & {e}_{ij} ∈ {E}_{2}\end{matrix} \vert$$

where (x,y,z)ϵe_ij represents all points on the edge e_ij. One edge is removed from E if the corresponding weight is greater than the OTSU 69 threshold on W. Consequently, vertexes S were clustered based on their connectivity. As opposed to inspecting each minimum, we treated each cluster, possibly including multiple minima, as one seed. This group-seeded watershed transformation on MAP reduces under- or over-segmentation errors.

### Cell Tracing and Identification

StarryNite and AceTree were used to automatically trace and assign identity of each nucleus by outputting nuclei positions and names. In CShaper, we leveraged these tools to name the segmentations described above. Generally, if one partition was associated with only a single nucleus, then the cell was named after the nucleus directly. However, at the beginning of cell division, two nuclei may coexist within one cell (enwrapped in the same membrane) during anaphase. In this case, the segmented region was named after the mother cell rather than the daughter cells. CShaper also defined a cavity inside an embryo when a partition was empty with no nucleus inside.

### Standardization of Embryo Samples

After linear normalization of the 46 embryos (Samples 04-49) as per the previously proposed pipeline, which consists of consecutive rounds of rotation (60 cycles), translation (60 cycles), and scaling (30 cycles) in x, y, and z axes to minimize the global positional variation between embryo samples \hat{ }9, four operations were subsequently carried out to establish a standard morphological atlas with normalized embryo size and orientation. First, a translation in the yz plane and rotation around the x axis was performed sequentially on the 17 embryos that expressed the membrane marker (Samples 04-20), which ensured that the focal planes of the first and last confocal images were parallel to the xz plane and distributed symmetrically on both sides of the xz plane. Second, a translation in the xz plane and rotation around the y axis were performed sequentially on the same embryos to keep their projection on the xz plane embedded by a centralized ellipse with the minimum area. Third, all 17 embryos were rescaled to their average size in the three orthogonal directions. Finally, the remaining 29 embryos labelled with only the nucleus marker (Samples 21-49) were linearly normalized to the average cell positions of the 17 embryos using the same loop algorithm composed of rotation, translation, and scaling.

### Definition of Effective Cell-Cell Contact

The following empirical criteria were used to establish effective contact between specific cells with potential biological relevance:

1. Contact area: a contact area is no < 1/48 of a cell's surface area. This area threshold is expected to be large enough for functional intercellular communication based on theoretical modelling. It is well known that each sphere is surrounded by 12 neighbours in a close-packed structure of equal-sized spheres, which in theory has the highest space occupancy and system stability. In the C. elegans embryo, the radius ratio between neighbour cells can reach upto 3:1). Thus, based on the hexagonal close-packed structure, we estimated the cell-cell contact area threshold by simulating how many cells with a radius ratio of up to ⅓ can be accommodated within space formed by a unit cell with a radius of 1. As a uniform neighbour cell can be replaced by, at most, four smaller cells with a radius ratio of ⅓, the relative contact threshold was set as 1/12×¼= 1/48.
2. Contact duration: a contact duration is no shorter than 3 min, i.e., two consecutive time points. This threshold was previously found to be satisfied by all the cell pairs with known Notch signalling in C. elegans.
3. Reproducibility: a contact is reproducible in all 17 embryos. As we focused on cell-cell contact necessary for normal development, reproducible contacts found in all samples were assumed to have the highest possibility of being functional. This requirement (100%) is high because the contact relationship obtained based on the membrane morphology is expected to be more reliable than that inferred from the nucleus position.

### Example 2

### Benchmarking of Segmentation Results

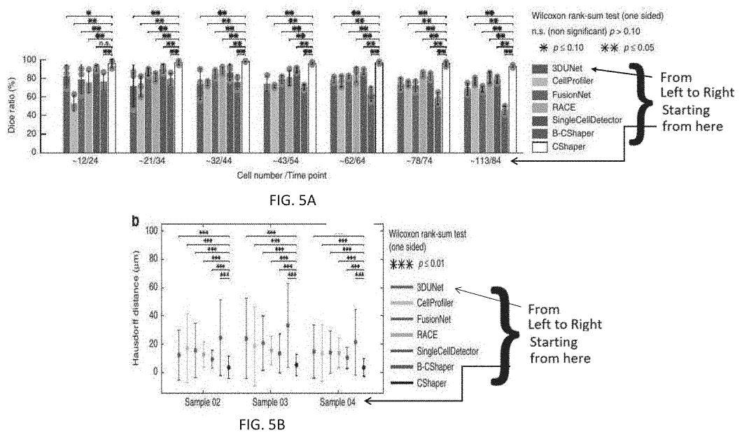

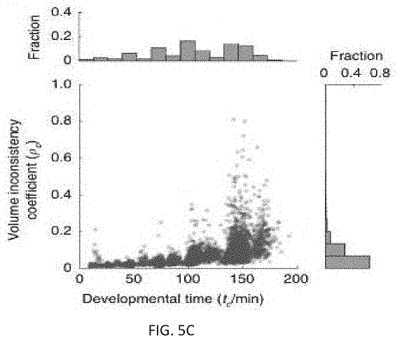

The method of the present invention was compared with other methods in cell segmentation, including 3DUNet, SingleCellDetector, FusionNet, RACE and CellProfiler. To allow a fair comparison, watershed algorithms were appended as a postprocessing procedure for 3DUNet and FusionNet where only binary membrane segmentation is available. A variant of the system of the present invention (CShaper) termed B-CShaper was tested to examine the superiority of the distance-constrained learning used by CShaper to the binary classification in B-CShaper. FIGS. 5A, 5B and 5B show the results of this comparison. FIG. 5A is a graph showing the dice ratio, as a pixel-level score, widely used to measure the similarity between computational segmentation results and the ground truth. After testing embryos at different cell stages, the present invention obtained a score of 95%, outperforming other methods by a significant margin. Therefore, in terms of the overlapped volume criteria, the segmentation results of the present invention were highly consistent with manual annotations.

1. A method for generating a morphological atlas of an embryo comprising the steps of:
receiving a plurality of 3D images of the embryo representative of the morphological process of embryonic cells from a first predetermined cell population to a second predetermined cell population;
processing the plurality of 3D images to derive nucleus lineage information associated with each nucleus of the embryonic cells during the morphological process;
performing a membrane segmentation procedure to segment the 3D images into membrane segments; and
combining the nucleus lineage information and the membrane segments to generate the morphological atlas of the embryo.

2. The method for generating a morphological atlas as claimed in claim 1, wherein the membrane segmentation procedure includes a machine learning processor arranged to process the 3D images of the embryo to create a discrete distance map representative of the positions of membranes within the 3D images.

3. The method for generating a morphological atlas as claimed in claim 2, wherein the machine learning processor uses a distance aware neural network trained to determine the positions of the membranes within the 3D images with the pixel location of the membranes.

4. The method for generating a morphological atlas as claimed in claim 2, wherein the membrane segmentation procedure further includes the steps of a seeding procedure and a watershed segmentation procedure to perform the membrane segmentation.

5. The method for generating a morphological atlas as claimed in claim 2, wherein the step of combining the nucleus lineage information and the membrane segments identifies the embryonic cells and cavity within the 3D image.

6. The method for generating a morphological atlas as claimed in claim 2, wherein the combination of the nucleus lineage information and the membrane segments is arranged to devise cell shape, cell size, cell-cell contact, or any combination thereof.

7. The method for generating a morphological atlas as claimed in claim 6, wherein the nucleus lineage information, the membrane segments, cell shape, cell size, cell-cell contact, or any combination thereof, is presented as the morphological atlas of the embryo undergoing the morphological process from the first predetermined cell population to the second predetermined cell population.

8. The method for generating a morphological atlas as claimed in claim 1, wherein the first predetermined cell population is 4, and the second predetermined cell population is 350.

9. The method for generating a morphological atlas as claimed in claim 1, wherein the embryo is a Caenorhabditis elegans embryo.

10. The method for generating a morphological atlas as claimed in claim 1, wherein the embryo is a Caenorhabditis elegans transgenic strain that expresses a GFP fluorescence marker and/or an mCherry fluorescence marker in the nuclei and/or membranes of the embryonic cells.

11. A system for generating a morphological atlas of an embryo, comprising:
a cell imaging unit arranged to receive a plurality of 3D images of the embryo representative of the morphological process of embryonic cells from a first predetermined cell population to a second predetermined cell population;
a nucleus tracing processor arranged to process the plurality of 3D images to derive nucleus lineage information associated with each nucleus of the embryonic cells during the morphological process;
a membrane segmentation processor arranged to perform a membrane segmentation procedure to segment the 3D images into membrane segments; and
a cell identification processor arranged to combine the nucleus lineage information and the membrane segments to generate the morphological atlas of the embryo.

12. The system for generating a morphological atlas as claimed in claim 11, wherein the membrane segmentation processor includes a machine learning processor arranged to process the 3D images of the embryo to create a discrete distance map representative of the positions of the membranes within the 3D images.

13. The system for generating a morphological atlas as claimed in claim 12, wherein the machine learning processor uses a distance aware neural network trained to determine the positions of the membranes within the 3D images with the pixel location of the membranes.

14. The system for generating a morphological atlas as claimed in claim 12, wherein the membrane segmentation procedure further includes the steps of a seeding procedure and a watershed segmentation procedure to segment the 3D images into the membrane segments.

15. The system for generating a morphological atlas as claimed in claim 12, wherein the cell identification processor is arranged to combine the nucleus lineage information and the membrane segments to identify the embryonic cells and cavity within the 3D image.

16. The system for generating a morphological atlas as claimed in claim 12, wherein the cell identification processor is arranged to combine the nucleus lineage information and the membrane segments to devise cell shape, cell size, cell-cell contact, or any combination thereof.

17. The system for generating a morphological atlas as claimed in claim 16, wherein the nucleus lineage information, the membrane segments, cell shape, cell size, cell-cell contact, or any combination thereof, is presented as the morphological atlas of the embryo undergoing the morphological process from the first predetermined cell population to the second predetermined cell population.

18. The system for generating a morphological atlas as claimed in claim 11, wherein the first predetermined cell population is 4, and the second predetermined cell population is 350.

19. The system for generating a morphological atlas as claimed in claim 11, wherein the embryo is a Caenorhabditis elegans embryo.

20. The system for generating a morphological atlas as claimed in claim 11, wherein the embryo is a Caenorhabditis elegans transgenic strain that expresses a GFP fluorescence marker and/or an mCherry fluorescence marker in the nuclei and/or membranes of the embryonic cells.
